(19) United States
(12) Patent Application Publication
(10) Pub. No.: US 2013/0107657 A1
(43) Pub. Date: May 2, 2013

(54) REMELTING TYPE THREAD ELEMENT FOR PARALLEL DUAL-SCREW EXTRUDER AND MANUFACTURING METHOD THEREOF

(71) Applicant: Peng Zhang, Dongguan City (CN)

(72) Inventor: Peng Zhang, Dongguan City (CN)

(21) Appl. No.: 13/810,188

(22) PCT Filed: May 6, 2011
(86) PCT No.: PCT/CN2011/073718

§ 371 Date: Jan. 14, 2013

(30) Foreign Application Priority Data
Jul. 26, 2010 (CN) 201010237204.9

(51) Int. Cl. B29B 7/80; B23P 15/00; B23K 9/00

(52) U.S. Cl. CPC B29B 7/80; B23K 9/0026; B23P 15/00
USPC 366/84; 219/137 R; 29/527.6

(57) ABSTRACT

A remelting type thread element for a parallel dual-screw extruder and a method for manufacturing the same are disclosed. The thread element includes a body (101) and a nickel-based tungsten carbide spray welding layer (102). Wherein, the nickel-based tungsten carbide spray welding layer is uniformly and eccentrically remelted on the external surface of the body. The manufacturing method comprises a steel billet casting process, a spray welding process, a remelting process and a machining process. The wearing resistance and corrosion resistance of the thread element are superior to the property of the domestic high-speed tool steel; it has reasonable structure, advanced process and low cost. The thread element has high property and price ratio, better social and economic benefit, and wide popularization and application value.

### TECHNICAL FIELD OF THE INVENTION

The present invention relates to a remelting type thread element and a method for manufacturing the same, particularly to a remelting type thread element for a parallel dual-screw extruder used in spray welding, remelting and machining fields, and a method for manufacturing the same.

### BACKGROUND

With development in the fields of plastics, cables, building materials and fodders, defects of mono-screw extruders such as low delivery efficiency, poor mixing homogeneity, low productivity, or the like have been considerably changed through wide use of parallel dual-screw extruders.

However, there is higher requirement for wear resistance and corrosion resistance of the thread element for a parallel dual-screw extruder due to continuous upgrading (continuous improvement in rotating speed) of parallel dual-screw extruders and large amount of highly wear resistant materials such as nylon, glass fibers and calcium carbonate and so on used in applications.

Nowadays, the most excellent high speed tool steel (W6Mo5Cr4v2) thread element arranged in domestic parallel dual-screw extruders will be worn and corroded in one to two months and have to be exchanged, when used in the environments containing nylon, glass fibers and calcium carbonate; that is, the lifespan thereof is quite short.

### SUMMARY OF THE INVENTION

In order to solve the problems present in the prior art, such as poor wear resistance and corrosion resistance of the thread element for a parallel dual-strew extruder and short lifespan, the present invention provides a remelting tape thread element for a parallel dual-screw extruder with high wear resistance and corrosion resistance.

The present invention further provides a method for manufacturing the remelting tape thread element for a parallel dual-screw thread extruder. The technical solution to solve the technical problems in the prior art is: providing a remelting tape thread element for a parallel dual-screw extruder, wherein the thread element comprises a body and a nickel-based tungsten carbide spray welding layer; the nickel-based tungsten carbide spray welding layer is uniformly and eccentrically remelted on the external surface of the body; the whole thickness of the nickel-based tungsten carbide spray welding layer is from 1.8 to 2.3 mm. According to a preferable technical solution of the invention, the body is a cast steel billet which is made of medium carbon steel.

According to a preferable technical solution of the invention, the nickel-based tungsten carbide spray welding layer comprises 61.75%˜60.8% of nickel, 33.25%˜32.7% of tungsten carbide, 3%˜4% of boron, 2%˜2.5% of silicon, and has a thickness of 1.8˜2.3 mm.

According to a preferable technical solution of the invention, there is a diffusion layer of 0.04˜0.1 mm between the body and the nickel-based tungsten carbide spray welding layer.

The invention also provides a method for manufacturing a remelting type thread element for a parallel dual-screw extruder, which comprises the following steps:

A: casting process of a steel billet: making a wax mold, selecting materials, melting them in a medium frequency furnace, casting a billet, demoulding and deburring, tempering and polishing;

B: spray welding process: ash propel polishing the cast steel billet, protecting in nitrogen, preheating the cast steel billet, spray welding the nickel-based tungsten carbide layer;

C: remelting process: putting the thread element of the spray welded nickel-based tungsten carbide into the electric vacuum furnace, protecting it by filling nitrogen, setting the temperature and time for remelting, setting a constant temperature and a period for maintaining the temperature, and tempering;

D: machining process: line cutting the end face of the thread element, broaching internal splines by a broaching machine, processing end faces, inner holes and chamfers by a Numerical Control Lathe, and coarsely grinding, semi-finishing grinding and finishing grinding by a Numerical Control grinder.

According to a preferable technical solution of the invention, step A particularly comprises:

A1: making a wax mold, selecting medium-temperature wax produced from America, zirconium ytterbium sand produced from Australia to fabricate a wax mold for casting according to the casting accuracy standards for a billet;

A2: selecting materials: selecting a steel ingot meeting the quality of the billet according to the cast accuracy and technical specification of the billet;

A3: melting in a medium frequency furnace: feeding the selected billet for casting into the medium frequency furnace to be heated to melt, and sufficiently mixing homogenously, with the furnace temperature set at 1400° C.˜1500° C.;

A4: casting a billet: pouring the liquid steel melt completely melt and sufficiently mixed in the medium frequency furnace into wax mold billets one by one;

A5: demoulding and deburring: demoulding the billet to be cast after being sufficiently cooled, and removing the zirconium ytterbium sand and burrs of remained on the billet;

A6: tempering: tempering the accurately cast steel billet thread element in a tempering furnace at 350° C.˜400° C., eliminating internal stress to prevent Hydrogen Embrittlement;

A7: polishing: polishing the tempered billet thread element, and removing the oxide scale and remained zirconium ytterbium sand.

According to a preferable technical solution of the invention, step B particularly comprises:

B1: ash propel polishing of the base billet: polishing the billet thread element, and removing the oxide scale and burrs of the product;

B2: protection in nitrogen: putting the polished billet thread element into a nitrogen protecting tank to be protected in nitrogen, so as to prevent the thread element being oxidized by contact with the air;

B3: preheating of the billet: taking the billet thread element out of the nitrogen protecting tank, and promptly penetrating it into a spline rod, and preheating it on a spray bed in clusters;

B4: spray welding of the nickel-based tungsten carbide layer: spray welding the nickel-based tungsten carbide layer on the external surface of the body.

According to a preferable technical solution of the invention, step C particularly comprises:

C1: putting the thread element of the spay welded nickel-based tungsten carbide into an electrical vacuum furnace to be remelted;

C2: protecting the thread element by filling nitrogen: injecting nitrogen into the electrical vacuum furnace with the thread element of the spay welded nickel-based tungsten carbide contained therein at a nitrogen pressure of from 0.1 kg m³ to 0.3 kg/m³;

C3: setting a remelting temperature: the remelting temperature of the thread element of nickel-based tungsten carbide in the electrical vacuum furnace is from 1000° C. to 1200° C.;

C4: setting a remelting time: the time for remelting and naturally cooling the thread element of nickel-based tungsten carbide in the electrical vacuum furnace is from 8 hours to 10 hours;

C5: setting the time for maintaining the constant temperature and the time for keeping heat preservation: the time for remelting the thread element of nickel-based tungsten carbide and maintaining the constant temperature in the electrical vacuum furnace is from 40 minutes to 50 minutes; and naturally cooling the thread element under heat preservation, wherein the time for keeping heat preservation is from 8 hours to 9 hours;

C6: tempering: tempering the remelted thread element of nickel-based tungsten carbide in a tempering furnace at a tempering temperature of from 350° C.˜400° C. for 2 hours to 2.5 hours, so that the internal stress in the element may be eliminated to prevent Hydrogen Embrittlement.

According to a preferable technical solution of the invention, step D particularly comprises:

D1: line cutting the qualified product of the remelted thread element of nickel-based tungsten carbide layer to process the end surface;

D2: putting the thread element having line cut end surface on a broaching bed to broach internal splines;

D3: putting the thread element having the broached internal splines on a Numerical Control lathe to process the end surface, inner holes and chamfers;

D4: putting the thread element processed by the Numerical Control lathe on a Numerical Control grinder to perform coarsely grinding, semi-finishing grinding and finishing grinding with 60#, 120#, 240# Emery wheels, respectively.

The remelting type thread element for a parallel dual-screw extruder of the invention has significantly better wear resistance and corrosion resistance than high speed tool steel (W6Mo5Cr4v2); and the wear resistance and corrosion resistance of the thread element produced by using new remelting process and materials of nickel-based tungsten carbide are above 4 times better than those of the high speed tool steel (W6Mo5Cr4v2).

The cost of steel will be 8 times less than that using conventional machining technique by replacing conventional process of a rod machine with the investment casting of the medium carbon billet of the remelting type thread element for a parallel dual-screw extruder, and a large amount of high qualified steel will be saved for the society.

The remelting type thread element for a parallel dual-screw extruder has advantages of low cost, reasonable structure, advantageous processes, high performance price ratio, considerable social and economical benefits, thus is worth of being widely developed and applied.

### BRIEF DESCRIPTION OF THE DRAWINGS

FIG. 1 is a schematic partial cross-sectional view of the structure of the remelting type thread element for a parallel dual-screw extruder of the invention;

FIG. 2 is a flow diagram of the method for producing the remelting type thread element for a parallel dual-screw extruder of the invention.

### DETAILED DESCRIPTION OF PREFERRED EXAMPLES

Hereinafter the technical solutions of the invention will be described in details in connection with the drawings.

The object of the invention is to provide a remelting type thread element of nickel-based tungsten carbide for a parallel dual-screw extruder for the fields of plastic machines, cable machines, building material machines and fodder machines, which has excellent wear resistance and corrosion resistance, much lower cost of manufacture and application, and largely enhanced productivity.

The remelting type thread element for a parallel dual-screw extruder of the invention may be a threaded sleeve or kneading block.

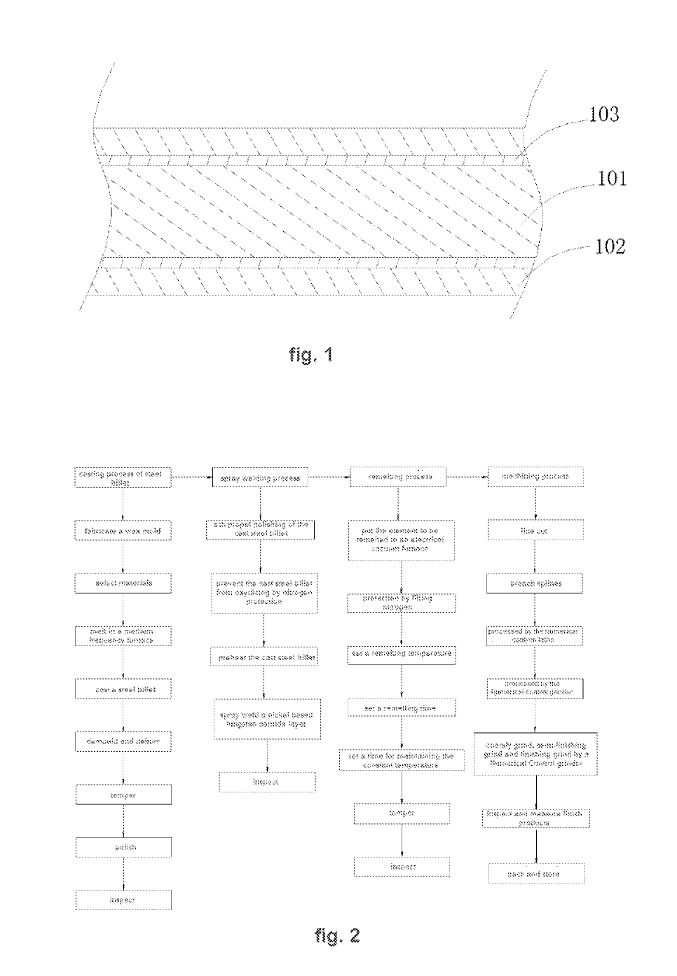

The schematic partial cross-sectional view of the structure of the remelting type thread element for a parallel dual-screw extruder of the invention may be referred to FIG. 1. As shown in FIG. 1, the invention provides a remelting type thread element for a parallel dual-screw extruder, which comprises a body 101 and a nickel-based tungsten carbide spray welding layer 102; and the nickel-based tungsten carbide spray welding layer 102 is uniformly and eccentrically remelted on the external surface of the body 101; the whole thickness of the nickel-based tungsten carbide spray welding layer 102 is from 1.8 to 2.3 mm.

According to a preferable technical solution of the invention, the body 101 is a cast steel billet which is made of medium carbon steel.

In a technical solution of the invention, the nickel-based tungsten carbide spray welding layer 102 comprises 61.75%˜60.80% of nickel, 33.25%˜32.7% of tungsten carbide, 3%˜4% of boron, 2%˜2.5% of silicon, and has a thickness of 1.8˜2.3 mm.

The inventors found that the thickness of the spray welding layer has critical effect on the surface machanical property of the remelting type thread element.

With 392 N of grinding load and 400 r/min of grinding speed, the inventors carried out wearing experiments with samples of the spray welding layers having a thickness of 0.5 mm, 1.0 m, 1.5 mm, 1.8 mm, 2.1 mm, 2.3 mm, 2.4 mm, 2.5 mm, respectively; the compositions for the spray welding layer of the samples are 60.80% of nickel, 32.7% of tungsten carbide, 4% of boron, and 2.5% of silicon. The wear time means the period for the samples became invalid.

The above examples are shown in table 1.

TABLE 1

| | | | | | wear | |
|---|---|---|---|---|---|---|
| | | | | | resistance | |
| | | | | | of the | |
| | | | | | tungsten | |
| | | | | | carbide | |
| | | grinding | grinding | wear | spray | |
| | thick- | load | speed | time | welding | |
| | ness | (N) | (r/min) | (h) | layer | others |
| Compar- | 0.5 | 392 | 400 | 180 | general | |
| ative | | | | | | |
| Example 1 | | | | | | |
| Compar- | 1 | 392 | 400 | 200 | general | |
| ative | | | | | | |
| Example 2 | | | | | | |
| Compar- | 1.5 | 392 | 400 | 240 | general | |
| ative | | | | | | |
| Example 3 | | | | | | |
| Example 4 | 1.8 | 392 | 400 | 880 | excellent | |
| Example 5 | 2 | 392 | 400 | 1000 | excellent | |
| Example 6 | 2.3 | 392 | 400 | 950 | excellent | |
| Compar- | 2.4 | 392 | 400 | | | chapped |
| ative | | | | | | under the |
| Example 7 | | | | | | operation |
| | | | | | | condition |
| Compar- | 2.5 | 392 | 400 | | | chapped |
| ative | | | | | | under the |
| Example 7 | | | | | | operation |
| | | | | | | condition |

When the thickness of the spray welding nickel-based carbide layer is less than 0.5 to 1.5 mm, the wear resistance is approximate to that of the high speed tool steel; and when the thickness of the spray welding nickel-based carbide layer is between 1.8 and 2.3 mm, the wear resistance is 4 to 5 times higher than that of the high speed tool steel. However, when the thickness of the spray welding nickel-based carbide layer is above 2.4 mm, the internal stress in the spray welding layer will increase sharply, and the spray welding layer will produce chaps during manufacture processes, and became invalid.

The inventors continued to making research on the effect of the compositions of the nickel-based tungsten carbide spray welding layer on the properties of the remelting type thread element. In the following experiments, the inventors selected the thickness of 2 mm, 392 N of grinding load, and 400 r/min of grinding speed for the nickel-based tungsten carbide spray welding layer.

### Comparative Example 1

nickel 85%, tungsten carbide 10%, boron 3%, silicon 2%; the worn amount is 0.00116 upon measuring the wear resistance;

### Comparative Example 2

nickel 75%, tungsten carbide 20%, boron 3%, silicon 2%; the worn amount is 0.00057 upon measuring the wear resistance;

### Comparative Example 3

nickel 65%, tungsten carbide 30%, boron 3%, silicon 2%; the worn amount is 0.00018 upon measuring the wear resistance;

### Comparative Example 4

nickel 61.75%, tungsten carbide 33.25%, boron 3%, silicon 2%; the worn amount is 0.00014 upon measuring the wear resistance;

### Example 5

nickel 60.80%, tungsten carbide 32.75%, boron 4%, silicon 2.5%; the worn amount is 0.00009 upon measuring the wear resistance;

### Example 6

nickel 55%, tungsten carbide 40%, boron 3%, silicon 2%; the worn amount is 0.00003 upon measuring the wear resistance.

The above examples are shown in table 2.

TABLE 2

| | | | | | | | | compared | |
|---|---|---|---|---|---|---|---|---|---|
| . | | | | | | | | with the | |
| | | | | | | | | wear | |
| | | | | | post- | | | resistance | |
| | | | | initial | ground | worn | | of | |
| | | grinding | grinding | weight | weight | weight | worn | W6M05C | |
| | material | load | speed | (g) | (g) | (g) | volume | r4V2 | others |
| | W6M05C | 392 | 400 | 35.2051 | 35.1631 | 0.0420 | 0.00119 | | |
| | r4V2 | | | | | | | | |
| Comparative | Ni 85% | 392 | 400 | 35.2054 | 35.1718 | 0.0410 | 0.00116 | general | |
| Example 1 | WC2 | | | | | | | | |
| | 10% | | | | | | | | |
| Comparative | Ni 75% | 392 | 400 | 35.2101 | 35.1900 | 0.0201 | 0.00057 | general | |
| Example 2 | WC2 | | | | | | | | |
| | 20% | | | | | | | | |
| Comparative | Ni 65% | 392 | 400 | 35.3212 | 35.3147 | 0.0065 | 0.00018 | general | |
| Example 3 | WC2 | | | | | | | | |
| | 30% | | | | | | | | |
| Example 4 | Ni | 392 | 400 | 35.1918 | 35.1868 | 0.0050 | 0.00014 | excellent | |
| | 61.75% | | | | | | | | |
| | WC2 | | | | | | | | |
| | 33.25% | | | | | | | | |
| Example 5 | Ni | 392 | 400 | 35.2353 | 35.2321 | 0.0032 | 0.00009 | excellent | |
| | 60.80% | | | | | | | | |
| | WC2 | | | | | | | | |
| | 32.7% | | | | | | | | |
| Comparative | Ni 55% | 392 | 400 | 35.2713 | 35.2701 | 0.0012 | 0.00003 | | brittlely |
| Example 6 | WC2 | | | | | | | | fractured |
| | 40% | | | | | | | | under |
| | | | | | | | | | the |
| | | | | | | | | | operation |
| | | | | | | | | | condition |
| Comparative | Ni 50% | 392 | 400 | 35.2713 | 35.2701 | 0.0012 | 0.00003 | | brittlely |
| Example 7 | WC2 | | | | | | | | fractured |
| | 45% | | | | | | | | under |
| | | | | | | | | | the |
| | | | | | | | | | operation |
| | | | | | | | | | condition |

When the content of tungsten carbide in the nickel-based tungsten carbide spray welding layer is less than 32.7%, the wear resistance is only 30% of that of the spray welding layer in which the content of tungsten carbide is 33.25%˜32.7%. However, when the content of tungsten carbide is higher than 33.25%, the brittleness of the nickel-based tungsten carbide spray welding layer sharply increases, and the flexility thereof sharply decreases. Therefore, when the compositions of the spray welding layer are Ni 61.75%˜60.80%, tungsten carbide 33.25˜32.7%, boron 3%˜4%, silicon 2%˜2.5%, the mechanical property of the remelting type thread element is optimal.

In a technical solution of the invention, there is a mutually melted layer 103 of 0.04 mm˜0.1 mm between the body 101 of cast steel billet and the nickel-based tungsten carbide spray welding layer 102, wherein the mutually melted layer 103 is a mutually melted layer 103 bonded in metallurgical state.

In order to make the remelting type thread element have excellent bonding ability in metallurgical state, and wear resistance and corrosion resistance, the cast steel billet in the remelting type thread element has a volume percent of 80%˜85%, and a weight percent of 70%˜78%; the nickel-based tungsten carbide layer has a volume percent of 20%˜15%, and a weight percent of 30%˜22%.

The remelting type thread element for a parallel dual-screw extruder of the invention is mainly applied in the fields of plastic machines, cable machines, building machines and fodder machines, and the like. The various technical parameters of the remelting type thread element are shown in the following table:

The remelting type thread element for a parallel dual-screw extruder shown in the table is a threaded sleeve.

| | | | | | | density of | | |
|---|---|---|---|---|---|---|---|---|
| | | | | | mutually | the | | |
| | | | tensile | | melted | remelted | | |
| | model/ | specification | strength | hardness | layer 103 | layer | wear | corrosion |
| name | type | mm | mpa | HRC | μm | g/cm³ | resistance | resistance |
| threaded | L/10T | 20~300 | ≧300 | ≧60 | ≧50 | 9.75 | excellent | excellent |
| sleeve | | | | | | | | |
| threaded | L/15T | 20~300 | ≧300 | ≧60 | ≧50 | 10.20 | excellent | excellent |
| sleeve | | | | | | | | |
| threaded | L/20T | 20~300 | ≧300 | ≧60 | ≧50 | 10.60 | excellent | excellent |
| sleeve | | | | | | | | |
| threaded | L/25T | 20~300 | ≧300 | ≧60 | ≧50 | 11.00 | excellent | excellent |
| sleeve | | | | | | | | |
| threaded | L/30T | 20~300 | ≧300 | ≧60 | ≧50 | 11.50 | excellent | excellent |
| sleeve | | | | | | | | |
| threaded | L/35T | 20~300 | ≧300 | ≧60 | ≧50 | 12.00 | excellent | excellent |
| sleeve | | | | | | | | |

Note:
The remelting threaded sleeve is constituted with model code (L), type code (10T~35T) and its specification parameters, in which the mode code (L) represents a threaded sleeve, the type code (10T~35T) represents the content of tungsten carbide, and the specification refers to the exterior diameter size of the threaded sleeve.

The remelting type thread element for a parallel dual-screw extruder shown in the table is a kneading block.

| | | | | | | density of | | |
|---|---|---|---|---|---|---|---|---|
| | | | | | mutually | the | | |
| | | | tensile | | melted | remelted | | |
| | model/ | specification | strength | hardness | layer 103 | layer | wear | corrosion |
| name | type | mm | mpa | HRC | μm | g/cm³ | resistance | resistance |
| kneading | N/10T | 20~300 | ≧300 | ≧60 | ≧50 | 9.75 | excellent | excellent |
| block | | | | | | | | |
| kneading | N/15T | 20~300 | ≧300 | ≧60 | ≧50 | 10.20 | excellent | excellent |
| block | | | | | | | | |
| kneading | N/20T | 20~300 | ≧300 | ≧60 | ≧50 | 10.60 | excellent | excellent |
| block | | | | | | | | |
| kneading | N/25T | 20~300 | ≧300 | ≧60 | ≧50 | 11.00 | excellent | excellent |
| block | | | | | | | | |
| kneading | N/30T | 20~300 | ≧300 | ≧60 | ≧50 | 11.50 | excellent | excellent |
| block | | | | | | | | |
| kneading | N/35T | 20~300 | ≧300 | ≧60 | ≧50 | 12.00 | excellent | excellent |
| block | | | | | | | | |

Note:
The remelting threaded sleeve is constituted with model code (N), type code (10T~35T) and its specification parameters, in which the mode code (L) represents a threaded sleeve, the type code (10T~35T) represents the content of tungsten carbide, and the specification refers to the exterior size of the kneading block.

The method for manufacturing the remelting type thread element for a parallel dual-screw extruder and the flow diagram thereof may refer to FIG. 2. As shown in FIG. 2, the method for manufacturing the remelting type thread element for a parallel dual-screw extruder comprises the following steps: first step, casting process of a billet steel: making a wax mold, selecting materials, melting them in a medium frequency furnace, casting a billet, demoulding and deburring, tempering and polishing;

second step: spray welding process: ash propel polishing the cast steel billet, protecting in nitrogen, preheating the cast steel billet, spray welding the nickel-based tungsten carbide layer;

third step: remelting process: putting the thread element of the spray welded nickel-based tungsten carbide into the electric vacuum furnace, protecting it by filling nitrogen, setting the temperature and time for remelting, setting a constant temperature and a period for maintaining the temperature, and tempering;

fourth step: machining process: line cutting the end face of the thread element, broaching internal splines by a broaching machine, processing end faces, inner holes and chamfers by a Numerical Control Lathe, and coarsely grinding, semi-finishing grinding and finishing grinding by a Numerical Control grinder.

In a specific technical solution of the invention, the first step particularly comprises:

1. making a wax mold, selecting medium-temperature wax produced from America, zirconium ytterbium sand produced from Australia to fabricate a wax mold for casting according to the casting accuracy standards for a billet;

2. selecting materials: selecting a steel ingot meeting the quality of the billet according to the cast accuracy and technical specification of the billet, preferably No. 45 steel in practice;

3. melting in a medium frequency furnace: feeding the selected billet for casting into the medium frequency furnace to heat to melt, and sufficiently mixing to be uniform with the furnace temperature set at 1400° C.˜1500° C.;

4. casting a billet: pouring the liquid steel melt completely melt and sufficiently mixed in the medium frequency furnace into wax mold billets one by one;

5. demoulding and deburring: demoulding the billet to be cast after being sufficiently cooled, and removing the zirconium ytterbium sand and burrs of remained on the cast steel billet;

6. tempering: tempering the accurately cast steel billet thread element in a tempering furnace at 350° C.˜400° C., eliminating internal stress to prevent Hydrogen Embrittlement;

7. polishing: polishing the tempered billet thread element, and removing the oxide scale and remained zirconium ytterbium sand;

8. inspecting: sending the polished thread element of cast steel billet to inspect, and placing the qualified products in boxes for future use.

In a specific technical solution of the invention, the second step particularly comprises:

1. ash propel polishing of the base billet: polishing the billet thread element, and removing the oxide scale and burrs of the product;

2. protection in nitrogen: putting the polished billet thread element into a nitrogen protecting tank to be protected in nitrogen, so as to prevent the thread element being oxidized by contact with the air;

3. preheating of the billet: taking the billet thread element out of the nitrogen protecting tank, and promptly penetrating it into a internal spline rod, and preheating it on a spray bed in clusters;

4. spray welding of the nickel-based tungsten carbide layer: spray welding the nickel-based tungsten carbide layer on the external surface of the body 101;

5. inspecting: inspecting the thread element with the nickel-based tungsten carbide layer spray welded thereon, and placing the qualified products in boxes to be delivered to the next remelting process.

In a specific technical solution of the invention, the third step particularly comprises:

1. putting the thread element with the spray welded nickel-based tungsten carbide into an electrical vacuum furnace to be remelted;

2. protection by filling nitrogen: injecting nitrogen into the electrical vacuum furnace with the thread element of the spay welded nickel-based tungsten carbide contained therein at a nitrogen pressure of from 0.1 kg m³ to 0.3 kg/m³;

3. setting a remelting temperature: the remelting temperature of the thread element of nickel-based tungsten carbide in the electrical vacuum furnace is from 1000° C. to 1200° C.;

4. setting a remelting time: the time for remelting the thread element of nickel-based tungsten carbide in the electrical vacuum furnace is from 8 hours to 10 hours;

5. setting the time for maintaining the constant temperature and the time for keeping heat preservation: the time for maintaining the thread element of nickel-based tungsten carbide at the constant temperature in the electrical vacuum furnace is from 40 minutes to 50 minutes, and the time for keeping heat preservation is from 8 hours to 9 hours;

6. tempering: tempering the remelted thread element of nickel-based tungsten carbide in a tempering furnace at a tempering temperature of from 350° C.˜400° C. for a time of from 2 hours to 2.5 hours, so that the internal stress in the element may be eliminated to prevent Hydrogen Embrittlement;

7. inspection: inspecting the remelted and tempered thread element of nickel-based tungsten carbide by eyes and instruments, and placing qualified products in boxes for a next machining process.

In a specific technical solution of the invention, the fourth step particularly comprises:

1. line cutting the qualified product of the remelted thread element of nickel-based tungsten carbide layer to process the end surface;

2. putting the thread element with line cut end surface on a broaching bed to broach internal splines;

3. putting the thread element with the broached internal splines on a Numerical Control lathe to process the end surface, inner holes and chamfers;

4. putting the thread element processed by the Numerical Control lathe on a Numerical Control grinder to perform coarsely grinding, semi-finishing grinding and finishing grinding with 60#, 120#, 240# Emery wheels, respectively.

5. inspection for finish products: inspecting and measuring the finish products of the remelted and machined element one by one, and classifying the qualified and unqualified products;

6. classifying the qualified products of the remelting type thread element upon inspection and measure, and packing and storing them.

The remelting type thread element for a parallel dual-screw extruder of the invention has significantly better wear resistance and corrosion resistance than high speed tool steel (W6Mo5Cr4v2); and the wear resistance and corrosion resistance of the thread element produced by using new remelting process and materials of nickel-based tungsten carbide may be up to above 4 times better than those of the high speed tool steel (W6Mo5Cr4v2).

The cost of steel will be 8 times less than that using conventional machining technique by replacing conventional process of a rod machine with the investment casting of the medium carbon billet of the remelting type thread element for a parallel dual-screw extruder, and a large amount of high qualified steel will be saved for the society.

The remelting type thread element for a parallel dual-screw extruder has advantages of low manufacture cost, reasonable structure, advantageous processes, high performance price ratio, considerable social and economical benefits, thus is worth of being widely developed and applied.

The above disclosure further describes the invention in details in connection with specific technical solutions, and can not be considered as limiting particular embodiments of the invention to these descriptions. As for those ordinarily skilled in the art, various simply inference or replacement may be performed, and shall be deemed as being within the protection scope of the invention, without departing from the concept of the invention.

What is claimed is:

1. A method for manufacturing the remelting tape thread element for a parallel dual-screw thread extruder, characterized in that:
the thread element comprises a body (101) and a nickel-based tungsten carbide spray welding layer (102);
the nickel-based tungsten carbide spray welding layer (102) is uniformly and eccentrically remelted on the external surface of the body (101); and
the whole thickness of the nickel-based tungsten carbide spray welding layer (102) is from 1.8 to 2.3 mm;
there is a diffusion layer (103) of 0.04 mm˜0.1 mm between the body (101) and the nickel-based tungsten carbide spray welding layer (102).

2. The remelting type thread element for a parallel dual-screw extruder of claim 1, characterized in that,
the body (101) is a cast steel billet which is made of medium carbon steel.

3. The remelting type thread element for a parallel dual-screw extruder of claim 1, characterized in that,
the nickel-based tungsten carbide spray welding layer (102) comprises 61.75%˜60.8% of nickel, 33.25%˜32.7% of tungsten carbide, 3%˜4% of boron, 2%˜2.5% of silicon.

4. A method for manufacturing the remelting type thread element for a parallel dual-screw extruder of claim 1, characterized in that,
the method for manufacturing the remelting type thread element for a parallel dual-screw extruder comprises the following steps:
A: casting process of a steel billet: making a wax mold, selecting materials, melting them in a medium frequency furnace, casting a billet, demoulding and deburring, tempering and polishing;
B: spray welding process: ash propel polishing the cast steel billet, protecting in nitrogen, preheating the cast steel billet, spray welding the nickel-based tungsten carbide layer;
C: remelting process: putting the thread element of the spray welded nickel-based tungsten carbide into the electric vacuum furnace, protecting it by filling nitrogen, setting the temperature and time for remelting, setting a constant temperature and a period for maintaining the temperature, and tempering; and
D: machining process: line cutting the end face of the thread element, broaching internal splines by a broaching machine, processing end faces, inner holes and chamfers by a Numerical Control Lathe, and coarsely grinding, semi-finishing grinding and finishing grinding by a Numerical Control grinder.

5. The method for manufacturing the remelting type thread element for a parallel dual-screw extruder of claim 4, characterized in that,
said step A particularly comprises:
A1: making a wax mold, selecting medium-temperature wax produced from America, zirconium ytterbium sand produced from Australia to fabricate a wax mold for casting according to the casting accuracy standards for a billet;
A2: selecting materials: selecting a steel ingot meeting the quality of the billet according to the cast accuracy and technical specification of the billet;
A3: melting in a medium frequency furnace: feeding the selected billet for casting into the medium frequency furnace to be heated to melt, and sufficiently mixing homogenously, with the furnace temperature set at 1400° C.˜1500° C.;
A4: casting a billet: pouring the liquid steel melt completely melt and sufficiently mixed in the medium frequency furnace into wax mold billets one by one;
A5: demoulding and deburring: demoulding the billet to be cast after being sufficiently cooled, and removing the zirconium ytterbium sand and burrs of remained on the billet;
A6: tempering: tempering the accurately cast steel billet thread element in a tempering furnace at 350° C.˜400° C., eliminating internal stress to prevent Hydrogen Embrittlement; and
A7: polishing: polishing the tempered billet thread element, and removing the oxide scale and remained zirconium ytterbium sand.

6. The method for manufacturing the remelting type thread element for a parallel dual-screw extruder of claim 4, characterized in that,
said step B particularly comprises:
B1: ash propel polishing of the base billet: polishing the billet thread element, and removing the oxide scale and burrs of the product;
B2: protection in nitrogen: putting the polished billet thread element into a nitrogen protecting tank to be protected in nitrogen, so as to prevent the thread element being oxidized by contact with the air;
B3: preheating of the billet: taking the billet thread element out of the nitrogen protecting tank, and promptly penetrating it into a spline rod, and preheating it on a spray bed in clusters;
B4: spray welding of the nickel-based tungsten carbide layer: spray welding the nickel-based tungsten carbide layer on the external surface of the body.

7. The method for manufacturing the remelting type thread element for a parallel dual-screw extruder of claim 4, characterized in that,
said step C particularly comprises:
C1: putting the thread element of the spay welded nickel-based tungsten carbide into an electrical vacuum furnace to be remelted;
C2: protecting the thread element by filling nitrogen: injecting nitrogen into the electrical vacuum furnace with the thread element of the spay welded nickel-based tungsten carbide contained therein at a nitrogen pressure of from 0.1 kg m³ to 0.3 kg/m³;
C3: setting a remelting temperature: the remelting temperature of the thread element of nickel-based tungsten carbide in the electrical vacuum furnace is from 1000° C. to 1200° C.;
C4: setting a remelting time: the time for remelting and naturally cooling the thread element of nickel-based tungsten carbide in the electrical vacuum furnace is from 8 hours to 10 hours;
C5: setting the time for maintaining the constant temperature and the time for keeping heat preservation: the time for remelting the thread element of nickel-based tungsten carbide and maintaining the constant temperature in the electrical vacuum furnace is from 40 minutes to 50 minutes; and naturally cooling the thread element under heat preservation, wherein the time for keeping heat preservation is from 8 hours to 9 hours;
C6: tempering: tempering the remelted thread element of nickel-based tungsten carbide in a tempering furnace at a tempering temperature of from 350° C.˜400° C. for 2 hours to 2.5 hours, so that the internal stress in the element is eliminated to prevent Hydrogen Embrittlement.

8. The method for manufacturing the remelting type thread element for a parallel dual-screw extruder of claim 4, characterized in that,
said step D particularly comprises:
D1: line cutting the qualified product of the remelted thread element of nickel-based tungsten carbide layer to process the end surface;
D2: putting the thread element having line cut end surface on a broaching bed to broach internal splines;
D3: putting the thread element having the broached internal splines on a Numerical Control lathe to process the end surface, inner holes and chamfers;
D4: putting the thread element processed by the Numerical Control lathe on a Numerical Control grinder to perform coarsely grinding, semi-finishing grinding and finishing grinding with 60#, 120#, 240# Emery wheels, respectively.
